(19) United States
(12) Patent Application Publication
(10) Pub. No.: US 2023/0358351 A1
(43) Pub. Date: Nov. 9, 2023

(54) Pipe Connection System

(71) Applicant: Michael Scott, Oklahoma City, OK (US)

(72) Inventor: Michael Scott, Oklahoma City, OK (US)

(21) Appl. No.: 17/736,831

(22) Filed: May 4, 2022

(51) Int. Cl. F16L 23/08

(52) U.S. Cl. CPC F16L 23/08; E21B 43/2607

(57) ABSTRACT

The present invention relates to an improved pipe connection system for conveying pressurized fracturing fluids from a wellbore through a fracturing tree in harsh environments with the ability for adjoining pipe sections to rotate. In one aspect, the improved pipe connection system includes a female connector, a male connector, one or more seals, a hinged clamp, and a closure. Pressurized fracturing fluid can flow from an end of the system and flow therethrough.

### CROSS REFERENCE TO RELATED APPLICATIONS

None.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood these statements are to be read in this light, and not as admissions of prior art.

The present invention generally relates to oil well operations. In particular, the invention relates to a pipe connection system for conveying pressurized fracturing fluids from a wellbore through a fracturing tree in harsh environments.

Production systems for oil and natural gas generally, include a wellhead assembly through which the resource is extracted. These wellhead assemblies may include a wide variety of components, such as various casings, valves, fluid conduits, and the like, that control drilling or extraction operations. Additionally, such wellhead assemblies may use a fracturing tree and other components to facilitate a fracturing process and enhance production from a well.

As will be appreciated, resources such as oil and natural gas are generally extracted from fissures or other cavities formed in subterranean rock formations or strata. To facilitate extraction of such resources, a well may be subjected to a fracturing process that creates one or more man-made fractures in a rock formation. Such fracturing processes typically include injecting a fracturing fluid—which is often a mixture including sand and water—into the well to increase the well's pressure and form the man-made fractures. A fracturing manifold may provide fracturing fluid to one or more fracturing trees via fracturing lines (e.g., pipes); however, the fracturing manifolds and associated fracturing trees are typically large and heavy and may be mounted to other equipment at a fixed location, making adjustments between the fracturing manifold and a fracturing tree difficult.

It is well known that current fracturing trees for delivering pressurized fluids are difficult to maintain. In general, the equipment used to direct the flow of fluid from a wellbore in extraction of natural resources present significant challenges to an operator. For example, it is often necessary to interrupt extraction operations to investigate a malfunction or to repair fracturing lines. Additionally, to be cost effective, once operations are complete at a first well pad site, the complex system of equipment must often be disassembled, transported, and reassembled at a different well pad site for reuse. These connections and disconnections consume a considerable amount of time.

Current technology involves threaded joints and hydraulic clamps to join fracturing lines within the fracturing tree. A threaded male end is connected to a threaded female end having a collar with big shoulders that workers beat with a hammer to tighten. This process regularly results in injuries. Additionally, hydraulic clamps are used to for connecting pipes within a fracturing line. Hydraulic clamps are inherently prone to various failures which creates unnecessary delays in the field.

Once a desired subterranean resource is discovered, drilling and production systems employed to access and extract the resource may be located onshore or offshore depending on the location of the desired resource. Space is a limiting factor at these extraction locations. Space for joining fracturing lines of the fracturing tree may be relatively limited in the field. Current technology does not allow for rotational movement between adjoining fracturing lines relative to one another.

For the foregoing reasons, there is a need for a pipe connection system that can deliver high-pressure fracturing fluid to a fluid distribution system in a harsh operating environment and allow for rotational movement of adjoining pipe sections.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention are generally directed to pipe connection systems that satisfy the need to deliver high-pressure fracturing fluid through a fracturing tree system in harsh operating environment with the ability for adjoining pipe sections to rotate. In one embodiment, the pipe connection system includes a female connector, a male connector, at least one seal, a hinged clamp, and a closure.

The female connector defines a central bore therethrough with a primary diameter and a larger second bore extends inwardly from an end that further defines an external shoulder adjacent to the end. The male connector defines a central bore therethrough substantially identical to the primary diameter. The male connector has a male projection that is adapted to be received within the second bore and defines at least one channel on an external surface of the male projection adapted to receive a seal. The male connector further has an external shoulder adjacent to a proximate end of the male projection. The seal engaged within each channel of the male connector is adapted to sealingly engage the second bore. A hinged clamp defines jaws which are adapted to envelop the shoulders for affixing the system in a colinear fashion. A closure means is provided for releasably joining the jaws of the hinged clamp and securing the pipe connection system.

An operator can easily and rapidly engage and disengage the female and male connectors with the hinged clamp. The system allows the connection between the female and male connectors to rotate while not under pressure to accommodate variable site conditions. The central bore (primary diameter) of the system can be configured from 2 inches to 9 inches.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of the present invention will become better understood with regard to the following description, appended claims, and accompanying drawings where:

FIG. 1 generally depicts a fracturing system in accordance with an embodiment of the present disclosure;

FIG. 2 is a diagram of the fracturing tree connected to the fracturing manifold of FIG. 1 by the fracturing lines featuring the pipe connection system.

FIG. 3 is a perspective view of the female connector;

FIG. 4 is a side view of the female connector;

FIG. 5 depicts a cross-section of the female connector of FIG. 4;

FIG. 6 is a perspective view of the male connector;

FIG. 7 is a side view of the male connector;

FIG. 8 depicts a cross-section of the male connector of FIG. 7;

FIG. 9 is a perspective view of the hinged clamp;

FIG. 10 is a front view of the hinged clamp;

FIG. 11 is a cross-section of the hinged clamp;

FIG. 12 is a side view of the male connector engaged with the female connector;

FIG. 13 is a perspective view of a pipe connection system;

FIG. 14 is a front view of the pipe connection system; and

FIG. 15 is a cross-section of the pipe connection system of FIG. 14.

### DESCRIPTION

The present invention will now be described more fully hereinafter with reference to the accompanying drawings, which illustrate various embodiments of the invention. This invention, however, may be embodied in many different forms and should not be construed as limited to the illustrated embodiments set forth herein; rather, these embodiments are provided so that this disclosure will be thorough and complete, and will fully convey the scope of the invention to those skilled in the art.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the” and “said” are intended to mean that there are one or more of the elements. The terms “comprising,” “including,” “having,” and grammatical equivalents thereof are intended to be inclusive and mean that there may be additional elements other than the listed elements. Moreover, any use of “top,” “bottom,” “above,” “below,” “left,” “right,” other directional terms, and variations of these terms is made for convenience, but does not require any particular orientation of the components.

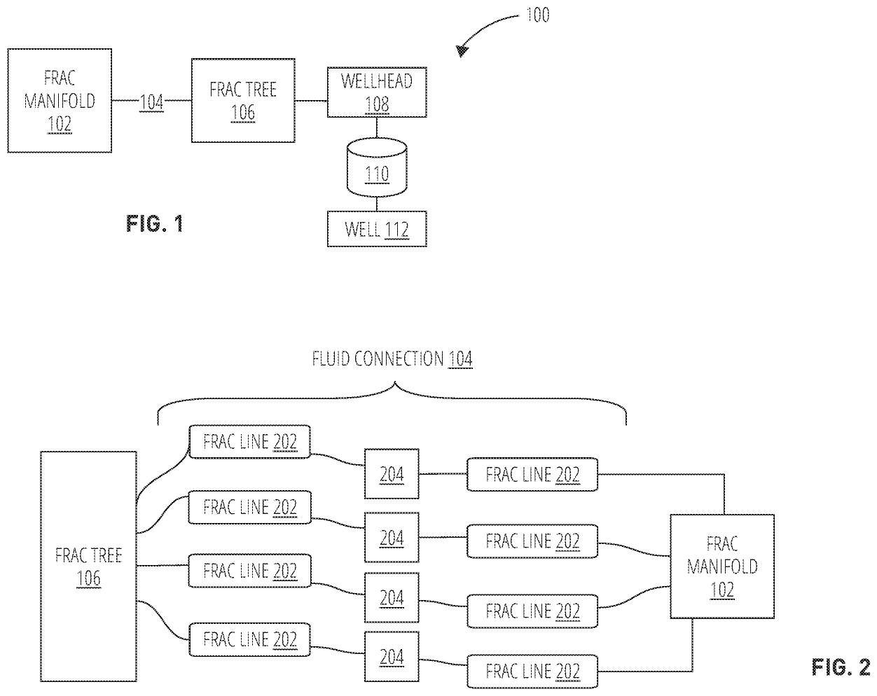

Turning now to the present figures, an example of a fracturing system 100 is provided in FIG. 1 in accordance with one embodiment. The fracturing system 100 facilitates extraction of natural resources (e.g., oil or natural gas) from a well 112 via a wellbore 110 and a wellhead 108. Particularly, by injecting a fracturing fluid into the well 112, the fracturing system 100 increases the number or size of fractures in a rock formation or strata to enhance recovery of natural resources present in the formation. In the presently illustrated embodiment of wellhead 108 the well 112 is a surface well accessed by equipment of wellhead 108 installed at surface level. It will be appreciated that natural resources may be extracted from other wells, such as platform or subsea wells.

The fracturing system 100 includes various components to control flow of a fracturing fluid into the well 112. For instance, the fracturing system 100 depicted in FIG. 1 and FIG. 2 includes a fracturing tree 106 connected a fracturing manifold 102 by a conduit or fluid connection 104 (e.g., pipes).

As depicted in FIG. 2, the fracturing tree 106 includes at least one fracturing line 202 that directs the flow of fracturing fluid. Similarly, the fracturing manifold 102 includes at least one fracturing line 202 that directs the flow of the fracturing fluid to the fracturing tree 106. But it is noted that the fracturing manifold 102 may instead be coupled to multiple fracturing trees 106 and wellheads 108. Fracturing lines 202 are a conduit or similar pipe. As described in further detail below, the adjoining fracturing lines 202 are connected by the pipe connection system 204. Such configuration allows for easier union of the fluid connection 104 between the fracturing tree 106 and the fracturing manifold 102.

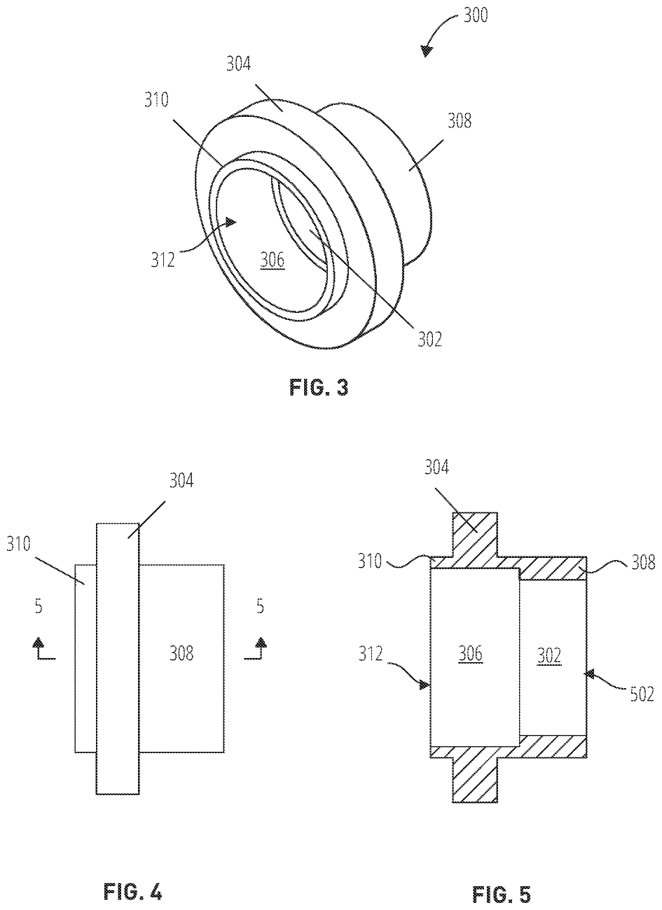

FIG. 3 is a perspective view of the female connector 300, in accordance with an embodiment of the present disclosure. The female connector 300 defines therein a substantially cylindrical conduit comprising a central bore 302 and a larger second bore 306. The second bore 306 extends inwardly from an end of the female connector 300 and an external shoulder 304 adjacent to the end of the female connector 300. A female receiver 310 extends from an end of the female connector 300. A female coupling 308 is welded or otherwise joined to a length of pipe having the same diameter as the central bore 302. The female coupling 308 is for connecting the female connector 300 to another component such as a fracturing line 202 within a fracturing fluid connection 104. The female connector 300 includes fluid ports 312 and 502 (FIG. 5) to transmit fluid through the female connector 300. In some embodiments, such as when installed in the fracturing system 100, the fluid port 312 may be considered an output port and the fluid port 502 may be considered an inlet port. But it is noted that the output port can be considered an inlet port in some embodiments.

In a preferred embodiment the female connector 300 is a single forged steel piece; however, to one skilled in the art, the material may be comprised of a variety of high strength steels and may be coated to increase corrosion resistance.

FIG. 4 is a side view of the female connector 300, in accordance with an embodiment of the present disclosure. Call-outs indicate the cross-section view of FIG. 5 of the female connector 300.

FIG. 5 is a cross-section of FIG. 4 of the female connector 300, in accordance with an embodiment of the present disclosure. A central bore 302 extends inwardly from a proximate end of the female connector 300. The second bore 306 having a larger diameter extending inwardly from an end opposite of the female connector 300. The central bore 302 and the second bore 306 mate at a location within the female connector 300 defining a cavity therethrough a minimum diameter equal to the primary diameter. The diameter of the central bore 302 is preferably equal to or greater than 2 inches. Fluid can flow from an end of the female connector 300 and flow therethrough. In a preferred embodiment the inner surface of the central bore 302 is corrosion resistant.

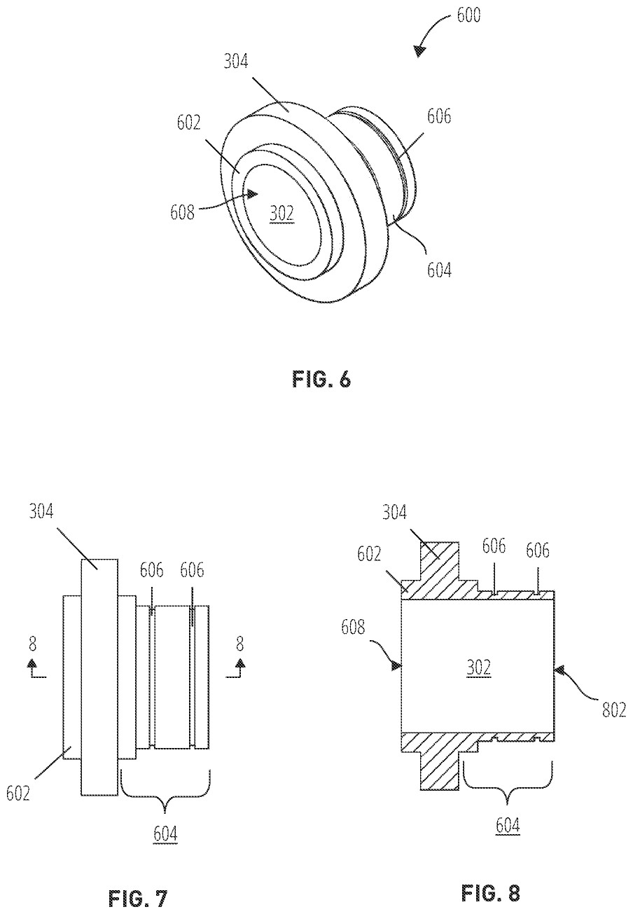

FIG. 6 is a perspective view of the male connector 600, in accordance with an embodiment of the present disclosure. The male connector 600 a substantially cylindrical conduit comprising a central bore 302, a male coupling 602, a male projection 604 and an external shoulder 304 adjacent to a proximate end of the male projection 604. The male projection 604 has a diameter adapted to be received within the second bore 306 of the female connector 300. The male projection 604 extends from an end of the male connector 600. The male projection 604 defines at least one channel 606 on an external surface adapted to receive a seal. A male coupling 602 is welded or otherwise joined to a length of pipe having the same diameter as the central bore 302. The male coupling 602 is for connecting the male connector 600 to another component such as a fracturing line 202 within a fracturing fluid connection 104. The male connector 600 includes fluid ports 608 and 802 (FIG. 8) to transmit fluid through the male connector 600.

In some embodiments, such as when installed in the fracturing system 100, the fluid port 608 may be considered an output port and the fluid port 802 may be considered an inlet port. But it is noted that the output port can be considered an inlet port in some embodiments. In a preferred embodiment the male connector 600 is a single forged steel piece; however, to one skilled in the art, the material may be comprised of a variety of high strength steels and may be coated to increase corrosion resistance.

FIG. 7 is a side view of the male connector 600, in accordance with an embodiment of the present disclosure. The external shoulder 304 of the male connector 600 having a diameter substantially the same as the external shoulder 304 of the of the female connector 300. Call-outs indicate the cross-section view of FIG. 8 of the male connector 600.

FIG. 8 is a cross-section of the male connector 600 of FIG. 7, in accordance with an embodiment of the present disclosure. A central bore 302 defining a conduit therethrough with a diameter substantially identical to the central bore 302 of the female connector 300. The conduit of the male connector 600 includes fluid ports 608 and 802 for transmitting fluid.

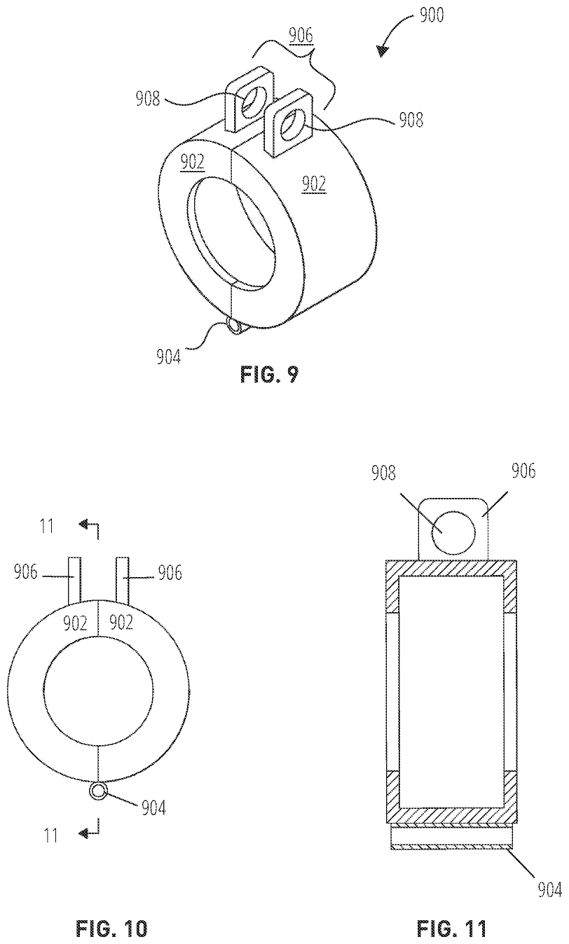

FIG. 9 a perspective view of the hinged clamp 900, in accordance with an embodiment of the present disclosure. The hinged clamp 900 includes at pair of jaws 902, and a closure 906. The hinge 904 is affixed at the bottom of the jaws 902. In a preferred embodiment of the hinged clamp 900 the closure 906, is affixed to the top of the pair of jaws 902, the closure 906 may be a pair of receivers for accepting a bolt 908 for joining the pair of jaws 902 of the hinged clamp 900, defining a collar. The collar of the hinged clamp 900 having an inside diameter and an outside diameter. In a preferred embodiment the hinged clamp 900, each jaw 902 is a single forged steel piece; however, to one skilled in the art, the material may be comprised of a variety of high strength steels and may be coated to increase corrosion resistance. As known to one skilled in the art, the hinge 904 allows for rotation of the jaws 902 about a fixed axis of rotation is common in clamps; however, a variety of hinge-like mechanisms can be implemented. Furthermore, as known to one skilled in the art, the pair of receivers for accepting a bolt 908 for securing the jaws 902 is common in clamps; however, a variety of closure mechanisms can be implemented such as a hinged bolt connected to a hinged joint, or a lever latch. The hinged clamp 900 secures the pipe connection system 204 in a colinear fashion. The hinged clamp 900 eliminates the need for a flange commonly used in the oil and gas industry to secure the pipe connection system 204. Rotation about an axis of rotation of the central bore 302 is possible when static while maintaining the female connector 300 mated to the male connector 600.

FIG. 10 is a front view of the hinged clamp 900, in accordance with an embodiment of the present disclosure. The inside diameter of the hinged clamp 900 having bore extending therethrough from an end of the hinged clamp 900. The inside diameter of the hinged clamp having a minimum diameter substantially similar to the outside diameter of the female connector 300 and the male connector 600.

FIG. 11 is a cross-section view of the hinged clamp 900 of FIG. 10, in accordance with an embodiment of the present disclosure.

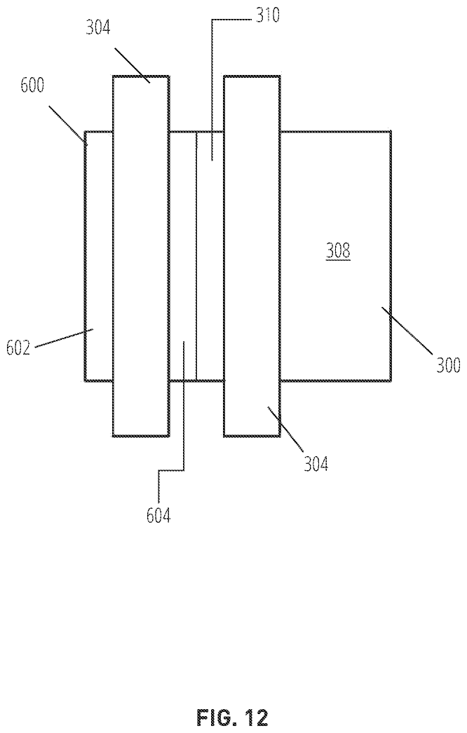

FIG. 12 is a side view of the male connector 600 engaged with the female connector 300.

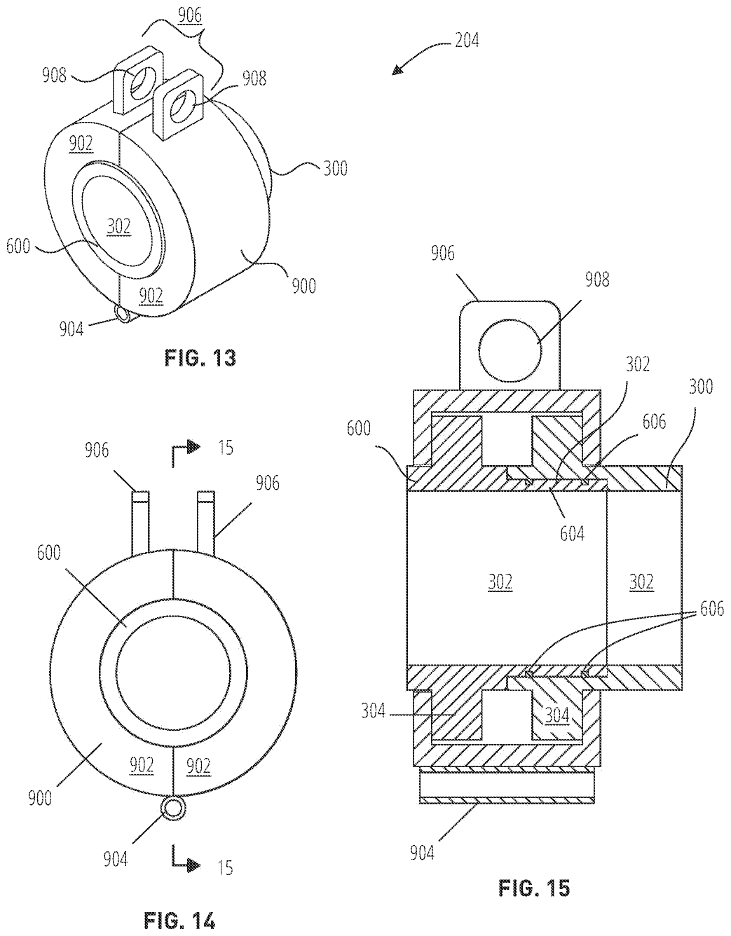

The pipe connection system 204, in accordance with one embodiment, is illustrated in greater detail in FIG. 13-FIG. 15. FIG. 13 is a perspective view of the pipe connection system 204 comprising a female connector 300 and a male connector 600 enveloped by a hinged clamp 900. Fluid can flow from an end of the pipe connection system 204 and flow therethrough within a central bore 302. The hinged clamp 900 comprises at least one jaw 902, and a closure 906. The hinge 904 is affixed at the bottom of at least one jaw 902. In a preferred embodiment of the hinged clamp 900 the closure 906, is affixed to the top of at least one jaw 902 for joining the at least one jaw 902 of the hinged clamp 900, with a pair of receivers for accepting a bolt 908, defining a collar. The collar of the hinged clamp hinged clamp 900 having an inside diameter defining a cavity for fitting with the male connector 600 and female connector 300. Fluid can flow from an end of the pipe connection system 204 and flow therethrough.

FIG. 14 is a front view of the pipe connection system 204 in a colinear fashion.

FIG. 15 is a cross-section of the pipe connection system 204. The pipe connection system 204 is affixed in a colinear fashion. The male connector 600, on the left, is a mated with the female connector 300, on the right, with the male projection 604 received within the second bore 306 of the female connector 300. The at least one channel 606 on the surface of the male projection 604 is depicted. The each seal is engaged with the channel 606 creating a hermetic seal with the female connector 300. The hinged clamp 900 enveloping the female connector 300 and male connector 600 mated with a surface of the external shoulders 304 of the female connector 300 and the male connector 600.

The pipe connection system 204 facilitates the flow of high pressurized fluid in harsh environments. In the presently illustrated embodiment, the pipe connection system 204 facilitates the flow of fracking fluid in harsh environments, but it will be appreciated that other high pressurized fluids may be facilitated as well, such as oil. The fracking fluid flows from an end of the pipe connection system 204 and can flow therethrough. The pressurized fluid can exceed 10 k psi reaching an excess of 20 k psi. The pipe connection system 204 securely facilitates the flow of fracking fluid.

The pipe connection system 204 expeditiously facilitates the flow of fluid when on site. The pipe connection system 204 allows for rotation of the female connector 300 and the male connector 600 when static providing a translational degree of freedom in aligning the fracking tree. Thus, eliminating the need of changing end connectors for varying degrees of connections.

The pipe connection system 204 further eliminates the need of using bolt-on flange commonly used in the oil and gas industry. It is well known that bolt-on flanges require a multitude of bolts. The fastening of each bolt is tedious and time consuming. The elimination of this flange saves on cost and time for securing the pipe connection system 204. The pipe connection system 204 provides a safe and secure alternative to other pipe connection systems of pressurized fluids.

Although the present invention has been described in considerable detail with reference to certain preferred versions thereof, other versions are possible. For example, the pair of receivers for accepting a bolt closure of the hinged clamp can be a hydraulic system. Therefore, the spirit and scope of the appended claims should not be limited to the description of the preferred versions contained herein. Any element in a claim that does not explicitly state “means for” performing a specified function, or “step for” performing a specific function, is not to be interpreted as a “means” or “step” clause as specified in 35 U.S.C § 112, ¶6. In particular, the use of “step of” in the claims herein is not intended to invoke the provisions of 35 U.S.C § 112, ¶6.

What is claimed is:

1. A pipe connection system for delivering high-pressure fluid to a fluid distribution system in a harsh operating environment, the system comprising:
a. a female connector defining a substantially cylindrical conduit, said conduit having:
i. a central bore defining an axis of rotation and an inner surface therethrough with a primary diameter,
ii. a larger second bore extending inwardly from an end of the female connector further defining a female receiver, and
iii. an external shoulder adjacent to the female receiver;
b. a male connector defining a substantially cylindrical conduit, said conduit having:
i. a central bore therethrough substantially identical to the primary diameter,
ii. a male projection adapted to be engaged by the second bore and defining at least one channel on an external surface of the male projection adapted to receive a seal,
iii. an external shoulder adjacent to an end of the male connector, and
iv. each seal engaged within each channel adapted to sealingly engage the second bore; and
c. a clamp defining at least one jaw adapted to envelop the external shoulders of the female connector and the male connector for affixing the pipe connection system in a collinear fashion having:
i. at least one hinge; and
ii. at least one closure for joining at least one jaw of the clamp and securing the pipe connection system;
whereby an operator can easily engage and disengage the male connector with the female connector and secure the pipe connection system with the clamp while allowing the female connector and male connector to rotate along the axis of rotation when the pipe connection system is not under pressure to accommodate variable site conditions.

2. The pipe connection system of claim 1, the female connector and the male connector each comprising single forged pieces.

3. The pipe connection system of claim 1, the primary diameter from 2 to 9 inches.

4. The pipe connection system of claim 1, where the inner surface of the central bore is corrosion resistant.

5. The pipe connection system of claim 1, the hinge comprising at least one jaw having a hinged joint connecting said jaw and further defining an opening for receiving a bolt within a terminal ends of each jaw.

6. The pipe connection system of claim 1, the closure is selected from a lever latch, hinged bolt and bolt.

7. The pipe connection system of claim 1, the closure comprising a hinged bolt affixed to the terminal end of at least one jaw and a slot defined in the terminal end of a second jaw adapted to receive the hinged bolt and engage a nut.

8. A pipe connection system for delivering high-pressure fluid to a fluid distribution system in a harsh operating environment, the system comprising:
a. a female connector defining a substantially cylindrical conduit, said conduit having:
i. a central bore defining an axis of rotation and an inner surface with a primary diameter,
ii. a larger second bore extending collinearly from an end of the female connector further defining a female receiver with an inner surface a secondary diameter, and
iii. an external shoulder adjacent to the female receiver;
b. a male connector defining a substantially cylindrical conduit, said conduit having:
i. the central bore therethrough substantially identical to the primary diameter,
ii. a male projection adapted to be engaged by the second bore and defining at least one channel on an external surface of the male projection adapted to receive a seal,
iii. an external shoulder adjacent to an end of the male connector, and
iv. the seal engaged within each channel adapted to sealingly engage the second bore; and
c. a hinged clamp defining a pair of jaws adapted to envelop the external shoulders of the female connector and the male connector for affixing the pipe connection system in a collinear fashion having:
i. a hinge affixed to the terminal end of the pair of jaws; and
ii. a pair of receivers for accepting a bolt closure for joining the pair of jaws and securing the pipe connection system;
whereby an operator can easily engage and disengage the male connector with the female connector and secure the pipe connection system with the hinged clamp while allowing the female connector and male connector to rotate along the axis of rotation when the pipe connection system is not under pressure to accommodate variable site conditions.
